(19) United States
(12) Patent Application Publication
(10) Pub. No.: US 2026/0213868 A1
(43) Pub. Date: Jul. 23, 2026

(54) OPTICAL TRANSMISSION LINK, OPTICAL TRANSMISSION SYSTEM AND OPTICAL TRANSMISSION METHOD

(71) Applicant: NTT, Inc., Tokyo (JP)

(72) Inventors: Koki SHIBAHARA, Musashino-shi (JP); Megumi HOSHI, Musashino-shi (JP); Yutaka MIYAMOTO, Musashino-shi (JP)

(73) Assignee: NTT, Inc., Tokyo (JP)

(21) Appl. No.: 19/138,012

(22) PCT Filed: Dec. 26, 2022
(86) PCT No.: PCT/JP2022/047827

§ 371 Date: Jun. 11, 2025

(51) Int. Cl. H04J 14/00; H04B 10/25

(52) U.S. Cl. CPC H04J 14/052; H04B 10/25

(57) ABSTRACT

The optical transmission link has a configuration in which a plurality of multicore fibers having the same characteristics and the same length are connected. When N is an integer of 2 or more, each multicore fiber has N pieces of cores arranged at equal intervals in an annular shape in a cross section thereof. When p is an integer of 0 or more to N−1 or less and an angular rotation of the multicore fiber with respect to a predetermined reference is (2π/N)×p, N pieces of the multicore fibers are connected by (N−1) pieces of connection points at a rotation angle at which p is not used repeatedly between N pieces of the multicore fibers.

### TECHNICAL FIELD

The present invention relates to an optical transmission link, an optical transmission system and an optical transmission method.

### BACKGROUND ART

With the start of 5th generation (5G) services, high definition video service distribution, development of Internet of things (IoT) services, and the like in recent years, communication traffic flowing through an optical network has been increasing year by year. As a countermeasure for the optical network to meet the increasing demand for communication traffic, for example, without changing a structure of an optical fiber as a transmission link, countermeasures have been taken, such as enhancement of functionality of an optical communication system device installed at a terminal station of the optical network and introduction of an optical amplifier and an optical switch.

As an optical fiber serving as a base of the current high-capacity optical network, a single mode fiber (SMF) is used except for a local network for a short distance such as a local area network (LAN). The SMF is an optical fiber that includes a single core serving as a path of an optical signal in a clad and is designed to allow only single mode propagation in a wavelength band such as the C-band or the L-band used in the large-capacity long-distance optical network. With this configuration, a large-capacity long-distance optical network that stably transfers information reaching several terabits per second over a long distance has been implemented.

In the optical network, a digital coherent transmission technology using a digital signal processing technology and a coherent transmission/reception technology is applied and introduced to an optical transmission device of a 100-gigabit-per-second class. The digital coherent transmission technology is a technology in which a coherent reception method and ultra-high-speed digital signal processing are combined. The coherent reception method is a reception method for detecting interference light between light on a reception side and local oscillation light. The ultra-high-speed digital signal processing is processing of digitizing a signal and then removing noise of a phase component caused by a frequency and phase fluctuation in a transmission side light source that generates signal light and a reception side light source that generates local oscillation light.

An optical transmission/reception module having characteristics of small size, low cost, and low power consumption and an optical transceiver using the same have been implemented by the digital coherent transmission technology without using a complicated phase locked loop or the like. With the advent of the digital coherent transmission technology, not only improvement of the reception sensitivity at the time of optical transmission in a large-capacity optical network, but also the information transmission efficiency can be dramatically improved by information being superimposed on the amplitude, the phase, or the polarization of an optical carrier wave.

However, in recent years, with the improvement of the information transmission efficiency, a theoretical limit of the transmission capacity that can be provided by the SMF is becoming apparent. Therefore, a space division multiplexing transmission technology has been regarded as a promising technology to overcome the above-described transmission capacity limit, in which a transmission medium is replaced with an optical fiber having a new structural form called a spatial multiplexing optical fiber and different pieces of independent information are placed on propagation light in each spatial degree of freedom in the optical fiber, and research and development have been advanced by related organizations around the world. As an example of a form of the spatial multiplexing optical fiber, for example, there is a multicore optical fiber (MCF) in which a plurality of cores is disposed in a clad. By handling the respective cores of the MCF as parallel independent transmission links, the transmission capacity per optical fiber can be greatly improved.

However, in the optical transmission system to which the above-described space division multiplexing transmission technology is applied, a performance limiting factor that has not been found in the SMF being an existing transmission medium becomes apparent. For example, in a case where an optical signal is input to each core of the MCF, phase matching occurs in some cases between the adjacent cores due to unintended optical fiber cable laying environmental conditions such as bending and vibration, and there are cases where an event occurs in which optical signals propagating between different cores interfere with each other. This phenomenon is called inter-core crosstalk (IXT), and it has been reported that the influence thereof behaves statistically as white noise between optical signals modulated at a modulation rate of about several tens of gigabaud (GBaud) and has cumulative characteristics with a transmission distance. Therefore, the IXT becomes a new performance limiting factor that degrades the signal-to-noise ratio of the optical signal in the optical transmission system together with the noise derived from the spontaneous emission light generated in the optical amplification process, and there is a concern that the IXT inherently limits the transmission capacity that the spatial multiplexing transmission link can provide.

The IXT can be partially compensated by applying signal processing based on a multiple-input multiple-output (MIMO) technology widely used in radio systems. For example, IXT compensation has been demonstrated, in which an evaluation verification system using a multicore fiber having seven cores as a transmission link is used, and it has been reported that an optical signal transmission distance can be extended by about 9% to 14% for each modulation method (see, for example, Non Patent Literature 1).

As described above, the IXT can be compensated in principle by the MIMO-type signal processing. However, because the throughput of the signal required in the optical transmission system reaches more than several tens of gigabits per second, it is essential to reduce a circuit scale in mounting a signal processing circuit operating in real time. As a parameter deciding the MIMO-type signal processing circuit scale for compensating the IXT, there are a spatial multiplicity N and a spread τ of the impulse response (hereinafter, simply referred to as “pulse spread”), and the circuit scale is scaled on the order of N²×τ. Therefore, it is important to reduce these parameters for signal processing circuit implementation.

As a method of reducing the pulse spread T, Non Patent Literature 1 discloses a method of inserting a delay adjustment fiber according to inter-core skew between adjacent cores for each relay span. Further, as another method, there are proposed a use of a coupled-type multicore fiber using a strong coupling state of an inter-core IXT by bringing cores in a clad of a multicore fiber close to an appropriate distance. In an uncoupled-type multicore fiber, τ has a characteristic of accumulating linearly with respect to a distance L with the accumulation of the inter-core skew, whereas in the coupled-type multicore fiber, τ has a characteristic of accumulating corresponding to the square root of the distance L (for example, Non Patent Literature 2).

Furthermore, as a similar method for reducing the pulse spread τ between spatial modes in a multimode fiber or a few-mode fiber, cyclic mode replacement for replacing a spatial mode for each transmission span has been proposed (see, for example, Non Patent Literature 3).

### CITATION LIST

### Non Patent Literature

Non Patent Literature 1: Ruben S. Luis, Georg Rademacher, Benjamin J. Puttnam, Yoshinari Awaji, and Naoya Wada, “Long distance crosstalk-supported transmission using homogeneous multicore fibers and SDM-MIMO demultiplexing”, Optics Express, Vol. 26, No. 18, p. 24044-24053, 2018.
Non Patent Literature 2: R. Ryf, J. C. Alvarado-Zacarias, S. Wittek, N. K. Fontaine, R. Essiambre, H. Chen, R. Amezcua-Correa, H. Sakuma, T. Hayashi, and T. Hasegawa, “Coupled-Core Transmission over 7-Core Fiber”, 2019 Optical Fiber Communications Conference and Exhibition (OFC), paper Th4B.3, 2019.
Non Patent Literature 3: K. Shibahara et al., “DMD-Unmanaged Long-Haul SDM Transmission Over 2500-km 12-Core×3-Mode MC-FMF and 6300-km 3-Mode FMF Employing Intermodal Interference Canceling Technique”, in Journal of Lightwave Technology, Vol. 37, No. 1, pp. 138-147, 2019.

### SUMMARY OF INVENTION

### Technical Problem

However, in the method using the delay adjusting fiber as described in Non Patent Literature 2, it is necessary to measure the inter-core skew of all the cores in advance before laying a fiber cable and prepare a fiber having an appropriate length in advance, and there is a concern that the introduction cost increases. Further, in the delay adjusting fiber, an optical signal propagating through each core of the multicore fiber needs to be coupled to the delay adjusting single-mode fiber. Therefore, a fan-in/fan-out device functioning as an interface of both of the above fibers needs to be inserted for every span, and there is a concern that a transmission loss increases. In addition, in the method using the coupled-type multicore fiber, τ still exhibits a monotonically increasing characteristic with respect to the distance L, and the effect is limited as a method for reducing τ.

Moreover, in the technique described in Non Patent Literature 3, similarly to the technique described in Non Patent Literature 1, there still is a necessity to insert a mode multiplexer/demultiplexer functioning as an interface between the fiber and the single mode fiber for every span, and an excessive transmission loss occurs.

In view of the above circumstances, an object of the present invention is to provide an optical transmission link, an optical transmission system, and an optical transmission method by which the scale of a circuit for compensating for the IXT of light transmitted through a multicore fiber can be reduced.

### Solution to Problem

An aspect of the present invention is an optical transmission link configured by connecting a plurality of multicore fibers having the same characteristics and the same length, in which, when N is an integer of 2 or more, the multicore fiber has N pieces of cores arranged at equal intervals in an annular shape in a cross section of the multicore fiber, and when p is an integer of 0 or more to N−1 or less and an angular rotation of the multicore fiber with respect to a predetermined reference is (2π/N)×p, N pieces of the multicore fibers are connected by (N−1) pieces of connection points at a rotation angle at which p is not used repeatedly between N pieces of the multicore fibers.

An aspect of the present invention is an optical transmission system including: a plurality of optical transmitters that transmits an optical signal; a spatial multiplexing multiplexer unit that multiplexes a plurality of the optical signals into a spatial multiplexing signal, the plurality of the optical signals being respectively transmitted from the plurality of optical transmitters; the optical transmission link that transmits the spatial multiplexing signal; a spatial multiplexing demultiplexer unit that divides the spatial multiplexing signal into a plurality of optical signals; a plurality of optical receivers that converts each of the plurality of the optical signals into an analog electrical signal, the plurality of the optical signals being obtained after dividing by the spatial demultiplexing demultiplexer unit; and a signal processing unit that compensates for crosstalk for each of a plurality of the analog electrical signals by using another analog electrical signal, in which the optical transmission link is configured by connecting a plurality of multicore fibers having the same characteristics and the same length, when N is an integer of 2 or more, the multicore fiber has N pieces of cores arranged at equal intervals in an annular shape in a cross section of the multicore fiber, and when p is an integer of 0 or more to N−1 or less and an angular rotation of the multicore fiber with respect to a predetermined reference is (2π/N)×p, N pieces of the multicore fibers are connected by (N−1) pieces of connection points at a rotation angle at which p is not used repeatedly between N pieces of the multicore fibers.

An aspect of the present invention is an optical transmission method including an optical transmission step of causing a plurality of optical signals that is subjected to spatial multiplexing to be transmitted through an optical transmission link configured by connecting a plurality of multicore fibers having the same characteristics and the same length, in which, when N is an integer of 2 or more, the multicore fiber has N pieces of cores arranged at equal intervals in an annular shape in a cross section of the multicore fiber, and when p is an integer of 0 or more to N−1 or less and an angular rotation of the multicore fiber with respect to a predetermined reference is (2π/N)×p, N pieces of the multicore fibers are connected by (N−1) pieces of connection points at a rotation angle at which p is not used repeatedly between N pieces of the multicore fibers.

### Advantageous Effects of Invention

According to the present invention, it is possible to reduce the scale of the circuit for compensating for the IXT of the light transmitted through the multicore fiber.

### BRIEF DESCRIPTION OF DRAWINGS

FIG. 1 A configuration diagram of an optical transmission system according to a first embodiment of the present invention.

FIG. 2 A diagram illustrating an example of a cross section of a transmission link fiber according to the first embodiment.

FIG. 3 A diagram for explaining correspondence of core numbers in a transmission link according to the first embodiment.

FIG. 4 A configuration diagram of an optical transmission system according to a second embodiment.

FIG. 5 A diagram illustrating an example of a cross section of a transmission link fiber according to the second embodiment.

FIG. 6 A diagram illustrating a connection configuration between an optical receiver and a signal processing unit according to the second embodiment.

FIG. 7 A diagram illustrating a result of a transmission experiment of the optical transmission system according to the first embodiment.

### DESCRIPTION OF EMBODIMENTS

Hereinafter, an embodiment of the present invention will be described in detail with reference to the drawings.

### First Embodiment

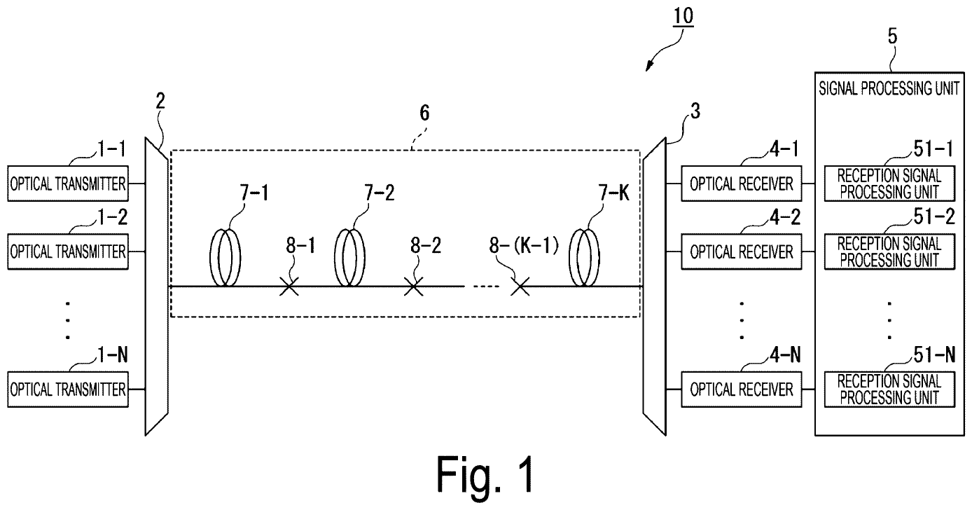

Hereinafter, a first embodiment of the present invention will be described with reference to the drawings. FIG. 1 is a diagram illustrating a configuration of an optical transmission system 10 according to the first embodiment. The optical transmission system 10 includes N pieces of optical transmitters 1, a spatial multiplexing multiplexer 2, a spatial multiplexing demultiplexer 3, N pieces of optical receivers 4, and a signal processing unit 5 (N is an integer of 2 or more). The spatial multiplexing multiplexer 2 and the spatial multiplexing demultiplexer 3 are connected to each other by a transmission link 6. The transmission link 6 has a configuration in which K (K is an integer of 2 or more) pieces of transmission link fibers 7 having the same characteristics and the same length are connected. The transmission link fiber 7 is a multicore fiber having N pieces of cores.

Hereinafter, N pieces of the optical transmitters 1 are referred to as optical transmitters 1-1 to 1-N, respectively, and N pieces of the optical receivers 4 are referred to as optical receivers 4-1 to 4-N, respectively. Further, K pieces of the transmission link fibers 7 are referred to as transmission link fibers 7-1 to 7-K. The transmission link fiber 7-k and the transmission link fiber 7-(k+1) are connected at a connection point 8-k (k is an integer of 1≤k<K). K may be a multiple of N or may not be a multiple of N. The side of the transmission link fiber 7-1 is referred to as upstream, and the side of the transmission link fiber 7-N is referred to as downstream.

The optical transmitter 1-n (n is an integer of 1≤n≤N) has a function of converting a bit string b-n that is an electrical signal into an optical signal. The optical transmitter 1-n generally includes a light source, a signal processing unit, a digital-to-analog (DA) converter, and an optical waveguide circuit therein. The optical waveguide circuit integrates optical modulation, optical amplification, optical multiplexing/demultiplexing, an optical monitoring function, and the like. In the present embodiment, descriptions of these configurations included in the optical transmitter 1-n are omitted.

The spatial multiplexing multiplexer 2 multiplexes the optical signals output from the optical transmitters 1-1 to the optical transmitter 1-N to generate a spatial multiplexing signal. The spatial multiplexing multiplexer 2 causes the optical signals from the optical transmitter 1-1 to the optical transmitter 1-N to be input to different cores of the transmission link fiber 7-1. The spatial multiplexing signal output from the spatial multiplexing multiplexer 2 propagates through the transmission link 6 having a configuration in which the transmission link fiber 7-1 to the transmission link fiber 7-K are connected.

The spatial multiplexing demultiplexer 3 receives the spatial multiplexing signal propagated through the transmission link 6 and divides the received spatial multiplexing signal into N pieces of optical signals. The spatial multiplexing demultiplexer 3 outputs the N pieces of optical signals obtained after the division to different ones of the optical receivers 4. With this configuration, for example, the optical signal of the bit string b-n is input to the optical receiver 4-n. The optical signal input to the optical receiver 4-n is converted into an analog electrical signal through an internal optical reception front end unit.

The signal processing unit 5 includes N pieces of reception signal processing units 51. N pieces of the reception signal processing units 51 are referred to as reception signal processing units 51-1 to 51-N, respectively. The reception signal processing unit 51-n receives the analog electrical signal converted by each of the optical receiver 4-1 to the optical receiver 4-N, performs IXT compensation based on the MIMO-type signal processing using the received N pieces of analog electrical signals, and obtains the bit string b-n. The reception signal processing unit 51-1 to the reception signal processing unit 51-N can operate in parallel.

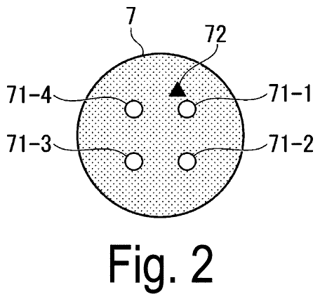

FIG. 2 is a schematic diagram illustrating an example of a cross section of the transmission link fiber 7. FIG. 2 illustrates an example of the transmission link fiber 7 having the number of cores N=4 arranged in a square lattice pattern. Four cores 71 of the transmission link fiber 7 are identified as a core 71-1 to a core 71-4 by a marker 72. The core 71 with the core number n (n is an integer of 1≤n≤N) is the core 71-n. It can also be said that these four cores 71 are annularly arranged at equal angular intervals from the center of the transmission link fiber 7. In FIG. 2, core numbers are assigned in ascending order from the core 71 closest to the marker 72 to the core 71 adjacent to that closest core 71.

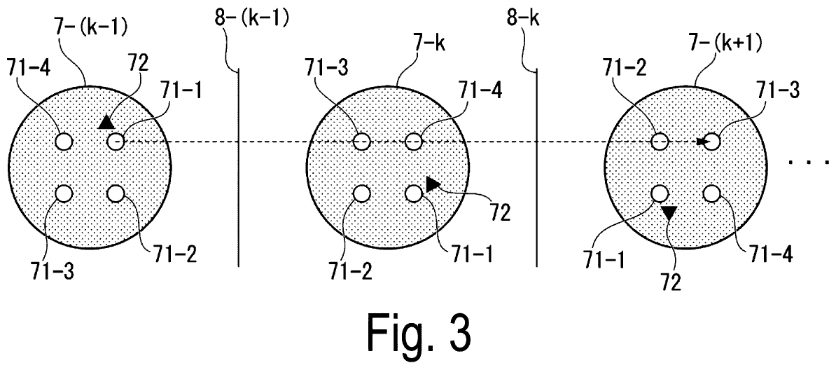

FIG. 3 is a diagram for explaining correspondence of core numbers from the transmission link fiber 7-(k−1) to the transmission link fiber 7-(k+1) in the transmission link 6 (k is an integer of 1<k<K). In the drawing, the cross sections of the transmission link fiber 7-(k−1) to the transmission link fiber 7-(k+1) are illustrated for ease of understanding. The transmission link fiber 7-(k−1) and the transmission link fiber 7-k are connected at the connection point 8-(k−1), and the transmission link fiber 7-k and the transmission link fiber 7-(k+1) are connected at the connection point 8-k.

The transmission link fiber 7 on the upstream side of the transmission link 6 and the transmission link fiber 7 on the immediately downstream side thereof are connected via each connection point 8 in a state after an angular rotation by 2π/N. In a case of N=4, the transmission link fiber 7 on the upstream side and the transmission link fiber 7 on the immediately downstream side thereof are connected after an angular rotation of π/2. Therefore, the optical signal propagated through the core 71-1 in the transmission link fiber 7-(k−1) propagates through the core 71-4 in the transmission link fiber 7-k, and propagates through the core 71-3 in the transmission link fiber 7-(k+1). A dotted arrow in FIG. 3 indicates the above correspondence between the cores 71 through which the optical signal propagates.

Note that the angular rotation is not limited to the above-described form, and in a case where the angular rotation of the transmission link fiber 7 with respect to a predetermined reference is (2π/N)×p (p is an integer of 0≤p≤N−1), the angular rotation of each of N pieces of the transmission link fibers 7 continuously connected by (N−1) pieces of the connection points 8 may be set so that p is not used repeatedly. In a case where the predetermined reference is any of N pieces of the transmission link fibers 7, p of the above transmission link fiber 7 is 0. For example, in the case of FIG. 3, assuming that the transmission link fiber 7-1 is used as a reference, the angular rotations of the transmission link fiber 7-2, the transmission link fiber 7-3, and the transmission link fiber 7-4 are (2π/N)×1, (2π/N)×2, and (2π/N)×3, respectively, but the angular rotations may be (2π/N)×3, (2π/N)×1, and (2π/N)×2.

According to the present configuration, because the optical signal propagating through each of the cores 71 makes one round of the four cores 71-1 to 71-4 every time the optical signal passes through the four transmission link fibers 7 although the order is different every time, the inter-core skew is canceled out. This is explained as follows. Assuming that a relative group velocity per unit distance of the core 71-i (i is an integer of 1 or more and N or less) is Ti, the optical signal propagated through the core 71-i experiences a relative skew of an amount of τᵢ×1 at a point of a distance 1. Here, it is assumed that the total length of the transmission links including the transmission link fiber 7-1 to the transmission link fiber 7-N is L. From the condition that the transmission link fibers 7 have equal lengths, the relative skew after propagation through the distance L is expressed by the following Expression (1) in all the spatial channels.

$$\begin{matrix}[ Math . 1 ] & \\ {\sum }_{i} {τ}_{i} ( L / N ) = {\sum }_{i} ( {τ}_{i} / N ) L & ( 1 )\end{matrix}$$

That is, the effective relative group velocity per unit distance according to the present configuration is the average of the original relative group velocities of all the cores 71, and is the same regardless of the spatial channel. Therefore, the relative inter-core skew experienced by the optical signal propagating through each core 71 is effectively 0. This enables the pulse spread T to be reduced.

Note that the connection at each connection point 8 is realized by a method of fusion splice connection, mechanical splice connection, or connector connection. That is, excessive loss caused by device insertion can be avoided by using a method that does not use a connection method involving an interface device between a multicore fiber and a single mode fiber such as fan-in/fan-out devices.

### Second Embodiment

Next, a second embodiment of the present invention will be described with reference to the drawings.

Hereinafter, the second embodiment will be described by focusing on differences from the first embodiment. The second embodiment aims to reduce the number of adjacent cores affected by the IXT and to reduce the scale of the MIMO-type signal processing.

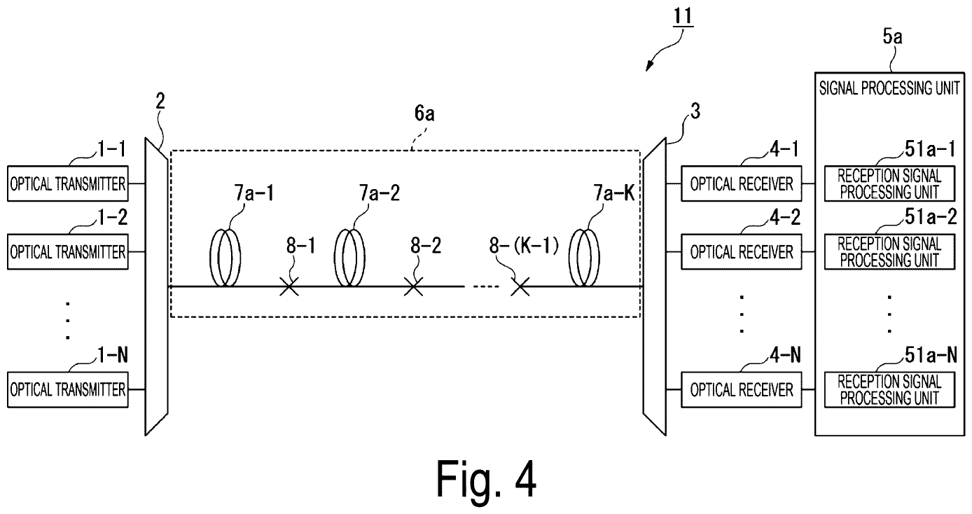

FIG. 4 is a diagram illustrating a configuration of an optical transmission system 11 according to the second embodiment. In FIG. 4, the same parts as those in the optical transmission system 10 according to the first embodiment illustrated in FIG. 1 will be denoted by the same reference signs, and description thereof will be omitted. The optical transmission system 11 illustrated in FIG. 4 is different from the optical transmission system 10 illustrated in FIG. 1 in that a transmission link 6a is provided instead of the transmission link 6 and a signal processing unit 5a is provided instead of the signal processing unit 5.

The transmission link 6a has a configuration in which K (K is an integer of 2 or more) pieces of transmission link fibers 7a having the same characteristics and the same length are connected. The transmission link fiber 7a is a multicore fiber having N pieces of cores. K pieces of the transmission link fibers 7a are referred to as transmission link fibers 7a-1 to 7a-K. Similarly to the transmission link fiber 7 of the first embodiment, the transmission link fiber 7a-k on the upstream side and the transmission link fiber 7a-(k+1) on the immediately downstream side are connected via a connection point 8-k in a state after an angular rotation by 2π/N (k is an integer of 1≤k<K). Note that, similarly to the first embodiment, in a case where the angular rotation of the transmission link fiber 7a with respect to a predetermined reference is (2π/N)×p (p is an integer of 0 or more and N−1 or less), the angular rotation of each of N pieces of the transmission link fibers 7a continuously connected by (N−1) pieces of the connection points 8 may be set so that p is not used repeatedly.

The signal processing unit 5a includes N pieces of reception signal processing units 51a. N pieces of the reception signal processing units 51a are referred to as reception signal processing units 51a-1 to 51a-N, respectively. The reception signal processing unit 51a-n performs the IXT compensation based on the MIMO-type signal processing to obtain a bit string b-n. Details of the reception signal processing unit 51a-n will be described later. The reception signal processing unit 51a-1 to the reception signal processing unit 51a-N can operate in parallel.

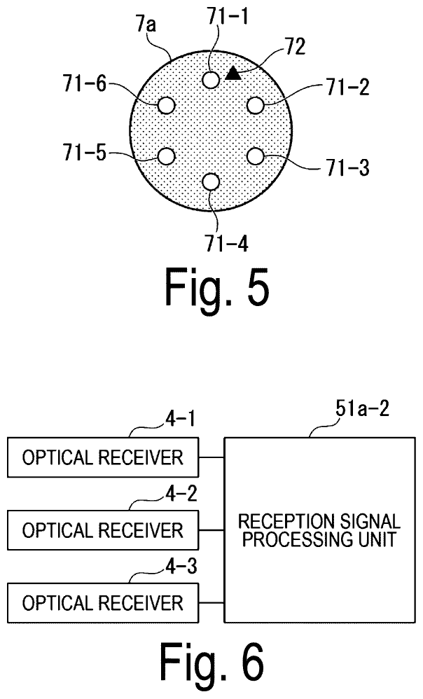

FIG. 5 is a diagram illustrating an example of a cross section of the transmission link fiber 7a according to the second embodiment. FIG. 5 illustrates a case where the number of cores N=6. The transmission link fiber 7a used in the second embodiment is a multicore fiber in which cores 71-1 to 71-6 are arranged on an annular ring. Core numbers are assigned in ascending order from the core 71 closest to a marker 72 to the core 71 adjacent to that closest core 71. The six-core multicore fiber illustrated in FIG. 5 as an example has a ring-shaped core arrangement arranged at equal angular intervals of π/3 (=2π/6). In each of the cores 71-1 to 71-6 of the multicore fiber having the present core arrangement, the IXT from the cores 71 adjacent to the left and right is dominant. For example, in the core 71-2, the IXT from the core 71-1 and the core 71-3 becomes dominant.

FIG. 6 illustrates a connection configuration between optical receivers 4 and the reception signal processing unit 51a-2 for detecting the bit string b-2 output from an optical transmitter 1-2. It is assumed that the optical signal of the bit string b-2 has propagated through the core 71-2 of the transmission link fiber 7a-k. In order to detect the bit string b-2, in the MIMO-type signal processing, in addition to waveform information of the optical signal propagated through the core 71-2 of the transmission link fiber 7a-k, by using waveform information of each of the optical signal propagated through the core 71-1 of the transmission link fiber 7a-k and the optical signal propagated through the core 71-3 of the transmission link fiber 7a-k, the optical signals causing the IXT to be dominant in the core 71-2 of the transmission link fiber 7a-k as described above, the IXT can be sufficiently compensated.

Specifically, the optical receiver 4-2 converts the optical signal transmitted through each of the cores 71 of the transmission link fibers 7a-1 to 7a-K including the core 71-2 of the transmission link fiber 7a-k into an analog electrical signal E2. Similarly, the optical receiver 4-1 converts the optical signal transmitted through each core 71 of the transmission link fibers 7a-1 to 7a-K including the core 71-1 of the transmission link fiber 7a-k into an analog electrical signal E1, and the optical receiver 4-3 converts the optical signal transmitted through each core 71 of the transmission link fibers 7a-1 to 7a-K including the core 71-3 of the transmission link fiber 7a-k into an analog electrical signal E3. The reception signal processing unit 51a receives the analog electrical signals E1 to E3 from the optical receivers 4-1 to 4-3, respectively. The reception signal processing unit 51a compensates the IXT of the analog electrical signal E2 by the MIMO-type signal processing by using the waveform information obtained from the analog electrical signal E1 and the waveform information obtained from the analog electrical signal E3, and acquires the bit string b-2 from the signal compensated for IXT. Here, the reception signal processing unit 51a-2 for detecting the bit string b-2 has been described, but the same applies to the reception signal processing unit 51a other than the reception signal processing unit 51a-2.

The configuration of the second embodiment corresponds to the MIMO-type signal processing of N=3 with respect to the circuit scale of the MIMO-type signal processing of N=6 required in the conventional configuration. Therefore, even in view of only the reduction effect of a spatial multiplicity N, the circuit scale is reduced to 25% as compared with the conventional configuration.

### Third Embodiment

In the third embodiment, the distance of the transmission link is limited, the distance enabling the reduction of the pulse spread τ in the first embodiment. As a simplest example, a description will be given using an example of a two-core multicore fiber having two cores. It is assumed that the two cores are Core #1 and Core #2. For simplicity, the relative group velocity per unit distance of Core #1 is denoted as τ₁, and the relative group velocity per unit distance of Core #2 is denoted as −τ₁. In general, assuming that a coupling coefficient between the cores is h, a value of inter-core crosstalk received by a signal after propagating a distance L corresponding to a transmission distance of one span can be approximated to hL (see, for example, Reference Literature 1). One span corresponds to a distance between relay amplifiers.
(Reference Literature 1) M. Koshiba et al., “Behavior of intercore crosstalk in square-layout uncoupled four-core fibers”, IEICE Electronics Express, Vo. 19, No. 18, p. 1-5, 2022.

Assuming that the angular rotation connection is performed at an intermediate point (distance L/2) of the span according to the first embodiment, the relative skew of the signal propagating through Core #1 and Core #2 becomes 0 at a point of the distance L. In addition, also for the inter-core crosstalk caused by phase matching at the point of the distance 0, the relative skew with the signal light is 0 at the point of the distance L. On the other hand, the inter-core crosstalk generated at other points causes a propagation delay of ±τ₁×L at the maximum at the time of propagation through the distance L, and the relative skew after one span transmission does not become 0. However, if the angular rotation connection is performed at the span intermediate point even after the second span, this inter-core crosstalk does not cause a relative delay greater than the above delay. Therefore, the power of the signal light and the inter-core crosstalk always exists within a time width of 2τ₁×L.

Next, the Mth-order crosstalk of the second-order or higher will be considered. Here, the Mth-order crosstalk is the inter-core crosstalk that the signal light receives after transitioning M times between the cores. With respect to the Mth-order crosstalk, it is not guaranteed whether the condition that the relative inter-core skew becomes 0 is satisfied, and the relative inter-core skew is determined according to a location where the crosstalk itself has occurred (phase matching has occurred) or the order of M. That is, the Mth-order crosstalk of the second order or higher is not necessarily present in the time width of 2τ₁×L, and thus becomes a factor of increasing the pulse spread τ. The distance at which such a phenomenon occurs is a distance at which a crosstalk approximate value (hL)² of the second-order crosstalk is of the same order as a first-order crosstalk approximate value hL, and thus, the distance is L satisfying hL to (hL)², that is, hL to 1. In the third embodiment, the transmission link distance is limited by 1/h.

As an example of a specific value, for example, a four-core step-type multicore fiber arranged in a square lattice shape has a coupling coefficient of approximately −40 to −30 dB/km in the 1.5 μm band. The distance of the transmission link of the third embodiment calculated from the above corresponds to 1,000 to 10,000 km.

### (Experimental Results)

A transmission experiment was performed to see the effects of the first embodiment. Each transmission link fiber 7 has a length of 5 km, and is a multicore fiber having four cores. Transmission link fibers 7 were fusion-spliced after the angular rotation by π/2, and pulse response spread was measured.

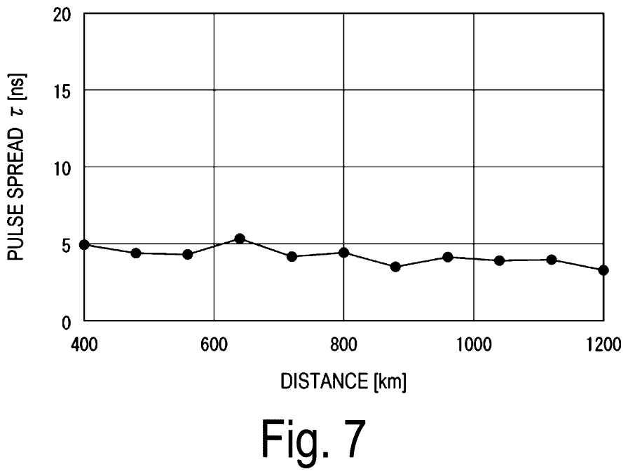

FIG. 7 is a diagram illustrating a result of pulse spread with respect to the transmission distance. As illustrated in FIG. 7, the pulse spread is constant regardless of the transmission distance, indicating that the relative skew of the optical signal and the IXT component is canceled out by the periodic core replacement.

As described above, according to the present embodiment, it is possible to cancel out the relative skew of the spatial multiplexing optical signal and the IXT component transmitted in the optical transmission system. Therefore, the calculation of MIMO-type signal processing for reducing the IXT between the signals can be reduced, and the circuit scale of MIMO-type signal processing can be reduced. Furthermore, it is possible to improve optical signal transmission characteristics and transmission capacity of the optical transmission system.

According to the embodiment described above, the optical transmission system includes a plurality of optical transmitters, a spatial multiplexing multiplexer unit, an optical transmission link, a spatial multiplexing demultiplexer unit, a plurality of optical receivers, and a signal processing unit. Each of the plurality of optical transmitters transmits an optical signal. The spatial multiplexing multiplexer unit multiplexes a plurality of optical signals transmitted from the plurality of optical transmitters into a spatial multiplexing signal. The optical transmission link transmits the spatial multiplexing signal. The spatial multiplexing demultiplexer unit divides the spatial multiplexing signal into a plurality of optical signals. The plurality of optical receivers convert each of the plurality of optical signals obtained after dividing by the spatial multiplexing demultiplexer unit into an analog electrical signal. The signal processing unit compensates for crosstalk for each of the plurality of analog electrical signals by using another analog electrical signal.

The optical transmission link is configured by connecting a plurality of multicore fibers having the same characteristics and the same length. When N is an integer of 2 or more, the multicore fiber has N pieces of cores arranged at equal intervals in an annular shape in a cross section thereof. When p is an integer of 0 or more to N−1 or less and an angular rotation of the multicore fiber with respect to a predetermined reference is (2π/N)×p, in the optical transmission link, N pieces of the multicore fibers are connected by (N−1) pieces of connection points at a rotation angle at which p is not used repeatedly between N pieces of the multicore fibers.

The signal processing unit may compensate for the crosstalk of the analog electrical signal converted from the optical signal transmitted through the core by using waveform information obtained from an analog electrical signal converted from an optical signal transmitted through a core adjacent to the concerned core in the multicore fiber. In addition, the distance of the optical transmission link may be equal to or less than an inverse number of the coupling coefficient h between the cores.

Although the embodiment of the present invention has been described in detail with reference to the drawings so far, specific configurations are not limited to the embodiment, and include designs, and the like, without departing from the gist of the invention.

### REFERENCE SIGNS LIST

1-1 to 1-N Optical transmitter
2 Spatial multiplexing multiplexer
3 Spatial multiplexing demultiplexer
4-1 to 4-N Optical receiver
5, 5a Signal processing unit
6, 6a Transmission link
7, 7-1 to 7-K, 7a, 7a-1 to 7a-K Transmission link fiber
8-1 to 8-(K−1)
10, 11 Optical transmission system
51-1 to 51-N, 51a-1 to 51a-N Reception signal processing unit
71-1 to 71-6 Core
72 Marker

1. An optical transmission link comprising a plurality of multicore fibers connected to each other, each of the multicore fibers having same characteristics and a same length, wherein,
when N is an integer of 2 or more, each of the multicore fibers has N pieces of cores arranged at equal intervals in an annular shape in its cross section,
when p is an integer of 0 or more to N−1 or less and an angular rotation of each of the multicore fibers with respect to a predetermined reference is (2π/N)×p, N pieces of the multicore fibers are connected by (N−1) pieces of connection points at a rotation angle at which p is not used repeatedly between N pieces of the multicore fibers.

2. The optical transmission link according to claim 1, wherein
the multicore fibers are connected by fusion splice connection, mechanical splice connection, or connector connection.

3. An optical transmission system comprising:
a plurality of optical transmitters that transmits an optical signal;
a spatial multiplexing multiplexer that multiplexes a plurality of the optical signals into a spatial multiplexing signal, the plurality of the optical signals having been respectively transmitted from the plurality of optical transmitters;
the optical transmission link that transmits the spatial multiplexing signal;
a spatial multiplexing demultiplexer unit that divides the spatial multiplexing signal into a plurality of optical signals;
a plurality of optical receivers that converts each of the plurality of the optical signals into a plurality of analog electrical signals, respectively, the plurality of the optical signals having been obtained after dividing by the spatial demultiplexing demultiplexer; and
a signal processor that compensates for crosstalk of each of the plurality of the analog electrical signals by using another analog electrical signal included in the plurality of the analog electrical signals, wherein
the optical transmission link is provided by connecting a plurality of multicore fibers having same characteristics and a same length,
when N is an integer of 2 or more, each of the multicore fibers has N pieces of cores arranged at equal intervals in an annular shape in its cross section, and
when p is an integer of 0 or more to N−1 or less and an angular rotation of each of the multicore fibers with respect to a predetermined reference is (2π/N)×p, N pieces of the multicore fibers are connected by (N−1) pieces of connection points at a rotation angle at which p is not used repeatedly between N pieces of the multicore fibers.

4. The optical transmission system according to claim 3, wherein
the signal processor compensates for crosstalk of a first analog electrical signal which is one of the plurality of analog signals having been converted from a first optical signal which is one of the plurality of optical signals having been transmitted through a first core which is one of the N pieces of cores by using waveform information obtained from a second analog electrical signal which is another one of the plurality of analog signals having been converted from a second optical signal which is another one of the plurality of optical signals having been transmitted through a second core which is another one of the N pieces of cores and adjacent to the first core.

5. The optical transmission system according to claim 3, wherein
the optical transmission link has a distance that is equal to or less than an inverse number of a coupling coefficient between the cores.

6. An optical transmission method comprising
transmitting, by an optical transmission link provided by connecting a plurality of multicore fibers having same characteristics and a same length, a plurality of optical signals which has been spatial multiplexed, wherein,
when N is an integer of 2 or more, each of the multicore fibers has N pieces of cores arranged at equal intervals in an annular shape in its cross section, and
when p is an integer of 0 or more to N−1 or less and an angular rotation of each of the multicore fibers with respect to a predetermined reference is (2π/N)×p, N pieces of the multicore fibers are connected by (N−1) pieces of connection points at a rotation angle at which p is not used repeatedly between N pieces of the multicore fibers.
